(19) United States
(12) Patent Application Publication
(10) Pub. No.: US 2003/0181538 A1
(43) Pub. Date: Sep. 25, 2003

(54) Grinding foam mixtures

(76) Inventors: Bryan Martel, Grass Valley, CA (US); Robert Villwock, Grass Valley, CA (US)

Correspondence Address: MORRISON & FOERSTER LLP, 1650 TYSONS BOULEVARD, SUITE 300, MCLEAN, VA, 22102, US

(21) Appl. No.: 10/357,517

(22) Filed: Feb. 4, 2003

Related U.S. Application Data
(60) Provisional application No. 60/353,227, filed on Feb. 4, 2002.

(51) Int. Cl. C08J 9/00

(52) U.S. Cl. 521/50

(57) ABSTRACT

Described are methods of grinding foams and foam powders produced by grinding foams. The methods include mixing foams together prior to grinding the foams. By mixing the foams together, the foams become easier to grind.

### FIELD OF THE INVENTION

This invention relates to techniques for grinding foams to form a foam powder. The techniques improve the grindability of foams.

### BACKGROUND OF THE INVENTION

Polymeric foams include a wide variety of materials, generally forming two-phase systems having a solid polymeric phase and a gaseous phase. The continuous phase is a polymeric material and the gaseous phase is either air or gases introduced into or formed during the synthesis of the foam. Some of these gases are known as “blowing agents.” Some syntactic polymeric foams contain hollow spheres. The gas phase of syntactic foams is contained in the hollow spheres that are dispersed in the polymeric phase. These spheres can be made of a variety of materials including glass, metal, carbon and polymers. Other materials such as fillers, reinforcing agents, and flame retardants can be used to obtain specific foam properties. Polymeric foams, open-celled or closed-cell, are usually classified as flexible, semi-flexible, semi-rigid, or rigid. Flexible foams, foams that recover after deformation, are typically used in carpet backing, bedding, furniture and automotive seating. Rigid foam, foams that do not recover after deformation, are used in thermal insulation, packaging, and load bearing components. Examples of polymers commonly used in foams include epoxy, fluoropolymer, latex, polyisocyanurate, polyimide, polyolefin, polystyrene, polyurethane, poly(vinyl chloride) (PVC), silicone, polyester, and urea-formaldehyde.

Typical foam manufacturing processes result in polymeric foam wastes. For example, a large quantity of slabstock polyurethane foam is produced commercially in a continuous pouring process. The resulting buns are often cut, for example, in pieces that are 1 to 2.5 m wide, 1.5 m high, and as long as 70 m. Foam buns are also made in boxes using batch processes. In either process, the outside of the bun is lined with a paper and/or plastic release sheet, for example, polypropylene-coated paper. A thin layer of foam skin is formed under the release sheet, and a heavier layer of foam skin is formed where there is no release sheet (for example, the top of the bun in some processes). The buns generally require trimming of the top and sides before the buns are cut or sliced for commercial use. These top and side trimmings include a foam waste product containing production contaminants.

The term “production contaminant” includes materials that are co-produced or used in the manufacture of slabstock or box foam, and are typically present in the scrap trimmed from the sides, top, and bottom of slabstock or box foam. Examples of production contaminants are those foam skins discussed above. Additionally, the term includes the release sheets or separators also discussed above, that are, e.g., of paper, paper coated with wax or polyolefin, and also may be of film, sheet, or netting made from polymer materials such as polyethylene, polypropylene, polystyrene, or other polyolefins. The release sheets containing some amount of any polymer are generically nominated as “polymeric sheets”. The skin material in trimmed scrap (or, “foam skins”) is quite different in consistency and density from the desired foam product. The skin material is a tougher, more rubbery product, and has a higher density than the desired foam product. Foam skins are layers of non-foam or very high density foam that are formed during the foam polymerization procedures. Foam skin is also present in scrap such as “mushrooms” of material from foam molding operations that escape the mold. Foam skin is also found in off-spec molded parts.

Trimmings also result from foam fabrication processes in which useful shapes are cut from the buns. This type of waste is called fabrication scrap, and it generally contains lower amounts of production contaminants than waste from trimming buns.

Polymeric foam waste is also present in many discarded foam-containing products such as furniture, automobile seats, thermal insulation foams, and packaging foams. This type of waste is called “post-consumer waste”. Post-consumer waste often contains contamination from other materials that were used in a fabricated part with the foam or from materials the foam was exposed to during its useful lifetime. These “consumer contaminants” include wood, ferrous metal, non-ferrous metal, textiles, leather, glass, dirt, oil, grease, adhesives, minerals, and plastics.

“Polyurethane” (PUR) describes a general class of polymers prepared by polymerization of diisocyanate molecules and one or more active-hydrogen compounds. “Active-hydrogen compounds” include polyfunctional hydroxyl-containing (or “polyhydroxyl”) compounds such as diols, polyester polyols, and polyether polyols. Active-hydrogen compounds also include polyfunctional amino-group-containing compounds such as polyamines and diamines. An example of a polyether polyol is a glycerin-initiated polymer of ethylene oxide or propylene oxide.

“PUR foams” are formed via a reaction between one or more active-hydrogen compounds and a polyfunctional isocyanate component, resulting in urethane linkages. As defined here, PUR foam also includes polyisocyanurate (PIR) foam, which is made with diisocyanate trimer, or isocyanurate monomer. PUR foams are widely used in a variety of products and applications. These foams may be formed in a wide range of densities and may be of flexible, semi-flexible, semi-rigid, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. “Semi-rigid” or “semi-flexible” foams are those that can be deformed, but may recover their original shape slowly, perhaps incompletely. A foam structure is formed by use of so-called “blowing agents.” Blowing agents are introduced during foam formation through the volatilization of low-boiling liquids or through the formation of gas during the reaction. For example, a reaction between water and isocyanate forms CO₂ gas bubbles in PUR foam. This reaction generates heat and results in urea linkages in the polymer. Additionally, surfactants may be used to stabilize the polymer foam structure during polymerization. Catalysts are used to initiate the polymerization reactions forming the urethane linkages and to control the blowing reaction for forming gas. The balance of these two reactions, which is controlled by the types and amounts of catalysts, is also a function of the reaction temperature.

Effective recycling technologies are highly desirable in order to re-use the foam waste, to use the raw material resources for these foams with maximum efficiency, to reduce or to eliminate the adverse environmental impact of polymeric foam waste disposal, and to make polymeric foam production more cost-effective.

It is desirable to recycle PUR foam by reducing that foam scrap to particles having a maximum particle size of about 2 mm and introducing the comminuted particles in making new flexible PUR foam, see for example U.S. Pat. No. 4,451,583, to Chesler. In the Chesler process, the comminuted particles are added to the reaction mixture for the new PUR, or to one of the reactive liquid components such as the polyhydroxyl compounds, and then new flexible foam is prepared in a conventional manner. Cryogenic grinding is disclosed in the '583 patent as a preferred grinding technique for forming the required foam scrap particle size.

U.S. Pat. No. 5,411,213, to Just, shows a process for grinding polymers such as PUR by adding a liquid anti-agglomeration or partitioning agent and subjecting the material to a compressive shear force using for example a two-roll mill. In another technique, disclosed in U.S. Pat. No. 4,304,873, to Klein, “micro-bits” of flexible PUR foam are prepared by subjecting shredded flexible PUR foam and a cooling fluid, such as water, to repeated impact by a plurality of impact surfaces. In yet another technique, U.S. Pat. No. 5,451,376, to Proska et al., discloses a PUR foam comminution process and apparatus wherein a fine comminution is carried out by forcing a mixture of coarsely comminuted material and one of the liquid PUR reaction components through one or more nozzles.

The grinding of foams is an energy intensive task that often requires foams to be recirculated through grinding equipment numerous times to achieve the proper particle size distribution for the comminuted foam powder. In addition, many foams are difficult or impossible to grind using conventional grinding techniques. Additionally, improved grindability provides finer particles for the same effort. Finer particles are preferable for use as a replacement for chemicals in new foam for several reasons: lower viscosity of powder/polyol slurries, improved foam properties, improved storage, conveying and handling of the powder, improved processing and mixing, and increased amount of foam powder that may be incorporated into a new foam.

Accordingly, a need exists for methods of causing the foams to grind more easily.

### SUMMARY OF THE INVENTION

This invention relates to techniques for grinding foams and foam powders produced by grinding foam. The techniques include blending different foams together and then grinding the blended foams. In one embodiment, the method of grinding polymer foams includes blending pieces of a first and second foam together to form a foam mixture and grinding the foam mixture to form a comminuted foam containing comminuted first and second foams. The first foam has a different composition or structure than that of the second foam and a grindability index GI-125 of the foam mixture is higher than a mass-averaged grindability index GI-125 of the foam pieces.

Preferably, the first foam has a grindability index GI-125 of less than 50. Preferably, the foam mixture has a grindability index GI-125 of greater than 50. Preferably, the first foam is an ester foam, reticulated foam, high-resilience foam, viscoelastic foam or conventional polyether foam. Preferably, the foam mixture comprises at least 1 wt % first foam and at least 1 wt % second foam.

Preferably, the comminuted foam is separated into a foam powder and an oversize-particles component. Preferably, the foam-powder component has a particle size of less than 2 mm. Preferably, the oversize-particles component is reground.

In another embodiment the method of preparing a polymer foam from recycled foams includes 1) blending pieces of a first foam and pieces of a second foam together to form a foam mixture; 2) grinding the foam mixture to form a comminuted foam comprising comminuted first and second foams; 3) separating the comminuted foam into a fraction comprising foam powder and a fraction comprising oversize particles; 4) mixing the foam powder with a polymerizable liquid; and 5) preparing a polymer foam from the foam powder and polymerizable liquid mixture. The first foam has a different composition or structure than that of the second foam and a grindability index GI-125 of the foam mixture is higher than a mass-averaged grindability index GI-of the first and second foams.

Another embodiment is a powder that includes a first comminuted foam and a second comminuted foam and yet another embodiment is a foam that includes a first comminuted foam and a second comminuted foam. The first foam has a different composition or structure than that of the second foam and a grindability index GI-125 of the foam mixture is higher than a mass-averaged grindability index GI-of the first and second foams.

An embodiment for making a slurry of comminuted foam in a polymerizable liquid is also included. The process for making the slurry includes blending pieces of a first foam and pieces of a second foam together to form a foam mixture; grinding the foam mixture to form a comminuted foam comprising comminuted first and second foams; and mixing the comminuted foam with a polymerizable liquid. The first foam has a different composition than that of the second foam and a grindability index GI-125 of the foam mixture is higher than a grindability index GI-125 of the first and second foams.

### BRIEF DESCRIPTION OF THE DRAWINGS

The invention will be better understood by reference to the Detailed Description of the Invention when taken together with the attached drawings, wherein:

FIG. 1A is a block diagram schematically illustrating the generic polymeric foam powder process of this invention.

FIG. 1B is a block diagram schematically illustrating a fragmenting and screening portion of the process illustrated in FIG. 1A.

FIG. 2A shows a two-roll mill device.

FIG. 2B shows a controller suitable for controlling the two-roll mill device of FIG. 2A; and

FIG. 3 is a bar graph showing the particle size distribution for the foam mixture described in Example 2.

FIG. 4 is a generic graph of grindability versus composition of a foam mixture illustrating the concept of mass-averaged grindability of a foam mixture.

### DETAILED DESCRIPTION

Described are methods of grinding foams to produce a foam powder. The methods include mixing a first foam with one or more other foams to produce a foam mixture. By mixing the first foam with another foam, the first foam can more easily be comminuted to produce a foam powder. Often, the grindability of the other foam or foams is also improved.

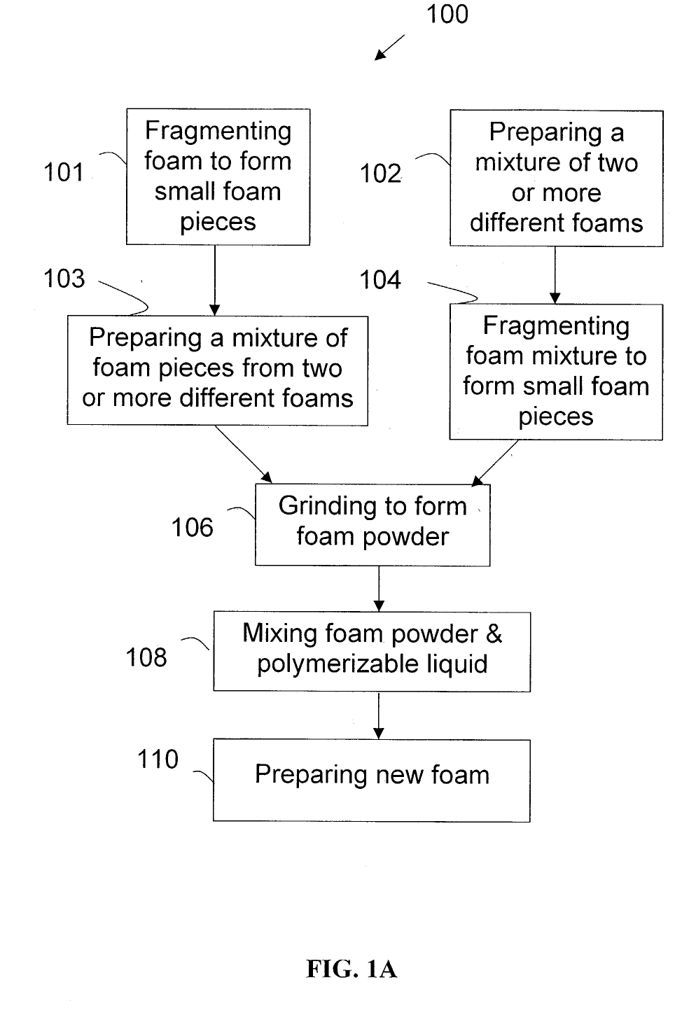

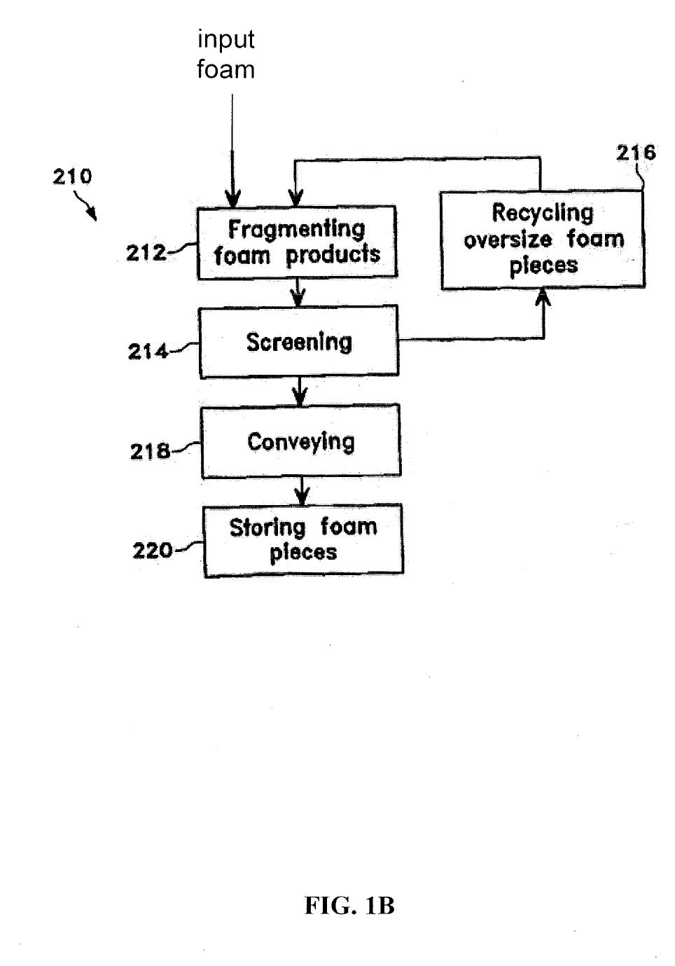

FIG. 1A shows a preferred process for comminution of polymeric foams to prepare foam powder particles and subsequently incorporating the foam powder in newly formed polymeric foams. The various processing steps of this inventive process may be combined to function cooperatively to form an integrated process as is schematically illustrated in FIG. 1A. FIG. 1A provides a summarized schematic illustration of an integrated process 100 having processing procedures 101, 102, 103, 104, 106, 108, and 110. Processing modules 101 and 103 is a first process for mixing different foams. Processing modules 102 and 104 provide a second process for mixing different foams.

Each processing module includes one or more processing steps or sequences. Processing modules 103 and 102 include processes for mixing together small foam pieces or processes for mixing together articles containing polymeric foam, respectively. Processing modules 101 and 104 include processes for fragmenting of articles containing polymeric foam, to prepare smaller foam pieces. Process Module 106 is a process for grinding the foam pieces to form a foam powder. Module 108 includes processes for preparing mixtures of foam powder and one or more polymerizable liquids. Optionally, mixtures of foam powder and polymerizable liquid may be comminuted using the methods of processing module 108, thereby providing a third-stage comminution of foam particles. Module 110 in FIG. 1A includes process steps for preparing solid polymeric foams by adding various ingredients to a mixture of foam powder and polymerizable liquid, and subsequently polymerizing the mixture to form a new foam that incorporates the foam powders of the present invention.

Processing module 103 includes processes suitable for mixing together small foam pieces (for example, less than 10 cm in size) of two or more different foams. Suitable methods for processing module 103 include using any of the technologies that are well known to those of ordinary skill in the art. Examples of processing methods for mixing together small foam pieces include silos, ribbon blenders, tumble blenders, and fluidization.

Processing module 102 includes processing suitable for mixing together two or more different foams or articles containing two or more different foams. Suitable methods for processing module 102 include using any of the technologies that are well known to those of ordinary skill in the art. Examples of processing methods for processing module 102 include mixing different foams during the feeding of or within module 104, mixing different foams within a bale and (without subsequently sorting the foams) processing that bale in module 104, and manual mixing of foams.

Processing modules 101 or 104 include processing sequence 210, shown in FIG. 1B. A first step 212 in processing sequence 210 includes fragmenting foam products and articles. Suitable methods for foam fragmentation step 212 include size reduction using any of the technologies that are well known to those of ordinary skill in the art. Examples of size-reduction equipment suitable for fragmenting foam in step 212 include comminution equipment types such as roll crushers utilizing two rolls counter-rotating at different speeds, impact mills utilizing for example hammer crushers, shredders employing shredder teeth on a single roll or using sawtooth and counter-rotating spacer assemblies, ring mills employing hooked rings attached to a rotor spinning at a high speed, and ring-roller mills utilizing rollers in conjunction with grinding rings. Examples of preferred size reduction equipment for step 212 include rotary grinders, hammer mills, and shear shredders.

Foam products and articles are introduced (not shown) into the size reduction equipment of step 212 using any of the techniques that are well known to those of ordinary skill in the art such as feeding the foam articles manually into the fragmentation equipment or using hoppers and/or conveyors. Processing modules 101 and 104 in (FIG. 1A) differ only in that a mixture of two or more different foams is introduced to processing module 104, while essentially single grades of foam are introduced to processing module 101. It will be understood that a preliminary size reduction step (not shown) may be executed prior to step 212 in order to reduce the foam articles to a size that is suitable for the fragmentation equipment of step 212.

Desirably, the size of the small foam pieces resulting from step 212 is less than about 50 cm. Preferably, this size is less than about 10 cm. More preferably, this size is less than about 2 cm. A specific size range is obtained by operating the size reduction equipment of step 212 at the required operating parameters, followed by a screening step 214. Foam pieces discharging from the fragmentation equipment of step 212 are screened in step 214 resulting in a target size, such as foam pieces no larger than about 10 cm, and oversize pieces including foam pieces larger than the target size. Suitable equipment for screening step 214 includes well known screening equipment using revolving, shaking, vibrating, oscillating or reciprocating screens. Oversize pieces are recycled to the fragmentation equipment in step 216 of processing sequence 210 (FIG. 1B). Recycling step 216 includes the use of devices such as conveyor belts, conveying screws, or pneumatic conveying, i.e. conveying in a gaseous flow, to return these foam pieces to the fragmentation equipment of step 214. Foam pieces within the target size range are conveyed in step 218 to foam piece storing step 220, using such conventional conveying techniques as conveying belts, conveying screws, or pneumatic conveying. Typically, fragmentation equipment suitable for the present technology has built-in components for screening and recycling of oversize pieces (steps 212, 214, and 216).

Storage facilities for executing optional storage step 220 may include storage bins, boxes and silos such as are used for bulk solids storage.

Processing module 106 (FIG. 1A) relates to grinding foam pieces and separating the comminuted foam to form a foam powder, which can be incorporated into new foam. A preferable foam powder has a particle size of about 2 mm or less, preferably less than about 0.25 mm, but likely larger than about 0.001 mm, e.g., 0.005 mm, including size ranges such as 0.001 mm to 0.010 mm, 0.001 mm to 0.020 mm, 0.001 mm to 0.045 mm, 0.001 mm to 0.150 mm, 0.005 mm to 0.010 mm, 0.005 mm to 0.020 mm, 0.005 mm to 0.045 mm, 0.005 mm to 0.150 mm, and any sub-ranges of these values. Foam powder having a particle size of 2 mm or less typically contains the broken parts of foam bubbles or cells without any substantial volume fraction (e.g., less than about 7.5%, preferably less than about 5%, and most preferably less than about 2.5% by volume) of complete cells or bubbles. Preferably, a majority (or all) of the particles are of such a size that, when viewed on a particle-by-particle basis, they do not have elongated sections left from the microscopic foam structure jutting from a central junction.

Processing module 106 (FIG. 1A) includes processes suitable for grinding foam pieces to form a foam powder. Suitable methods for processing module 106 include using any of the technologies that are well known to those of ordinary skill in the art. Examples of processing methods for processing module 106 include grinders, sifters, particle classifiers, and screeners.

A grinder can be any apparatus capable of comminuting foam using frictional, shear, tensile, compressive, or pressure forces. Conventional grinding processes for mechanically reducing foam to the desired particle size are preferred. More preferred, are grinding processes that take advantage of the Bridgmen effect, whereby foams are comminuted by means of the combined action of pressure and shear forces. Grinding process that utilize the Bridgmen effect include roll mills, solid-state shear extrusion, and other processes as described in U.S. Pat. Nos. 5,669,559, to Wagner et al, and 5,769,335, to Shutov.

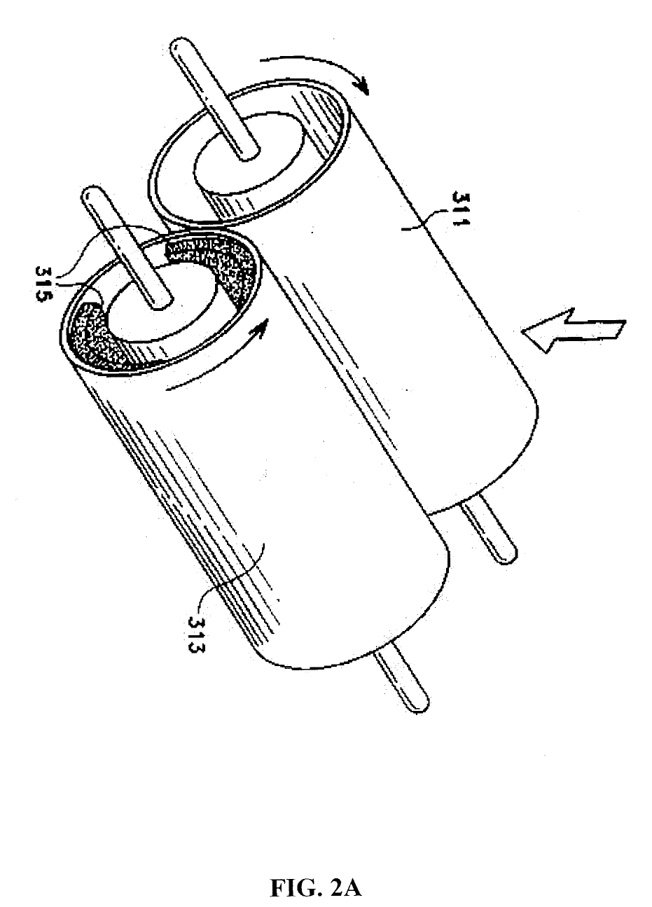

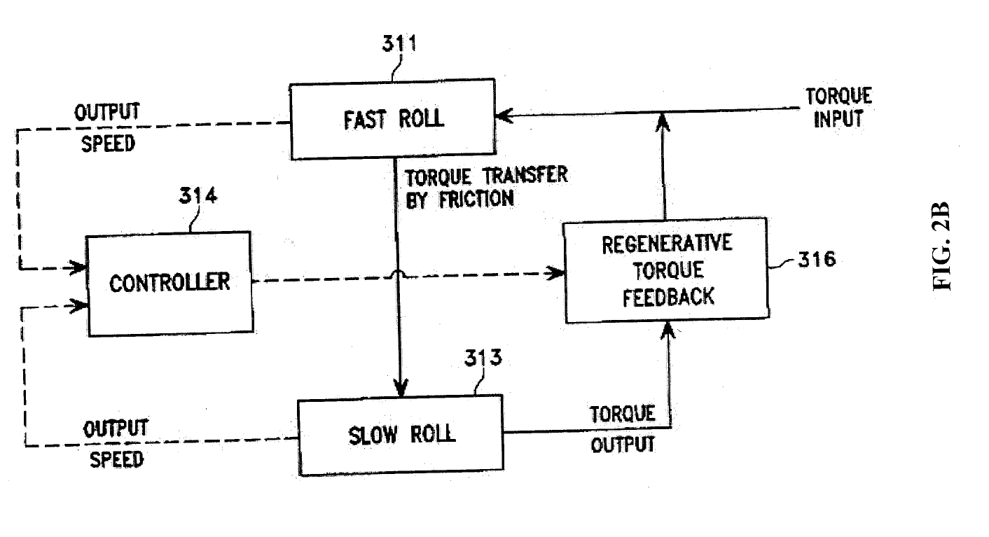

A particularly preferred grinding process is described in published U.S. patent application Ser. No. 09/748,307, incorporated herein by reference, which makes use of a two-roll mill and sifters. FIGS. 2A and 2B show an example of a preferred type of two-roll mill. FIG. 2A shows a pair of rollers: a faster, driven roll 311 and a relatively slower roll 313 that may be driven at least in part by the fast roll 311. “Faster” and “slower” in this context refer to the relative surface speeds of the rolls. There is a differential speed where the rolls meet and shear the foam between them. In this variation of the invention, the fastest roll 311 may be driven by an electric motor or the like (not shown), while the second roll 313 is indirectly driven by the first roll through the friction between the directly driven roll and the material in the nip between the two rolls.

The speed reduction on the slow roll 313 may be achieved by mechanical braking using brake shoes 315 in order to maintain the desired speed ratio between the two rolls. The speed reduction may alternatively be obtained with the generation of electrical or hydraulic power.

The differential in surface speed between the two rolls improves the efficiency of the comminution step. The ratio of the respective surface speeds may be between 10:1 and just above 1:1, preferably between 10:1 and 3:1, more preferably between 8:1 and 3:1, and most preferably between 5:1 and 3:1. The peripheral speed of the rolls is generally 0.1 to 10 m/s, preferably 0.1 to 4.5 m/s, and most preferably 0.1 to 3.0 m/s.

FIG. 2B shows a schematic outline of a control scheme for the FIG. 2A device in which torque output from the slow roll may be monitored by controller 314 and used to control torque feedback from the slow roll 313 to the fast roll 311 in order to maintain a desired differential in the roll speeds.

Another particularly preferred grinding process is a pellet mill as discussed in D. A. Hicks et al., “Performance of MDI Pour-In-Place Automotive Seating Incorporating Recycled Content”, J. Cellular Plastics, 32, 191-211 (1996). Pellet mills operate by the action of hardened rollers traveling over a perforated die plate. The rollers compact and press the material to be comminuted through the die holes. Below the die, a knife cuts the emerging compacted material to granules of the desired length. Polyurethane foams emerge from a pellet mill as a friable pellet, which can be easily broken apart to make foam powder.

Jet mills, impact mills or cutting mills such as hammer mills, pin mills, granulators, Fitzpatrick comminuting machines, and media mills, such as ball mills and rod mills, may also be used to grind foams.

A grinding method may include pre-treating the foam using any technique that increases the fragility of the foam material, for instance by cooling the foam with cryogenic fluids (e.g., liquid nitrogen), or contacting the foam with certain solvents.

Processing module 106 may also include a step wherein comminuted material exiting the grinder is separated into at least two fractions comprising a foam-powder fraction with particles of a desired size, and an oversize fraction with particles of a larger size. Foam pieces discharging from the grinder of module 106 may be separated, resulting in a foam powder (such as foam powders having particle-size ranges described above), and a fraction containing oversize pieces including foam pieces and powder larger than the target size. Suitable equipment for this separation step includes the various techniques for separation of fine particles from mixtures as are well known to those of ordinary skill in the art, for example screening equipment using revolving, shaking, vibrating, oscillating or reciprocating screens or sifters, or air classifiers, or cyclones, or elutriators. A preferred device for the separation step is a centrifugal sifter. The fraction containing the oversize material may be recirculated to the grinder of processing module 106. Said recirculation may include the use of devices such as conveyor belts, conveying screws, or pneumatic conveying, i.e. conveying in a gaseous flow, to return the oversize material to the grinder. Foam powder within the target size range may be conveyed to temporary storage or directly to processing module 108 (mixing with a polymerizable liquid), using such conventional conveying techniques as conveying belts, conveying screws, or pneumatic conveying.

In processing module 108, foam powder is mixed with a polymerizable liquid to form a slurry, for example a slurry of foam powder in polyol. In processing module 110, new polymer is prepared from the polymerizable-liquid slurry. For example a polyurethane foam may be prepared from a slurry of foam powder in polyol.

It has been found that not all foams react in the same way when subjected to grinding forces. Some foams are difficult or impossible to grind using standard grinding equipment, while other foams are easily comminuted into powders. Surprisingly, the grindability of many hard-to-grind foams can be improved by mixing them with other types of foams and then grinding the foam mixture. In addition, in many cases, even the grindability of easy-to-grind foams can be improved by mixing them with other foams and grinding them as part of a mixture.

It has also been found that not all comminuted foams react in the same way when processed with a separator to separate a fine fraction of foam powder from an oversize fraction. Some comminuted foams are difficult or impossible to separate using standard separating equipment such as a sifter, while other comminuted foams are easily separated into foam powders and oversize fractions. Surprisingly, the separability of individual comminuted foams of many types can be improved by first mixing those foams with other types of foams and then grinding the foam mixture to make a comminuted foam with higher separability.

By first mixing foams of different types, higher production rates and finer foam powders are obtained from a grinding circuit that includes a grinder and a particle-size separator with means for conveying materials between the various processing steps. These improvements may be due to improved performance of the grinder, improved performance in the particle-size separation, improved performance of the conveying means, reduction in plating of fine powder within pneumatic conveying equipment, and/or reduced triboelectric charging of foams and comminuted foams. Such improvements may also or otherwise be due to changes in the surface properties of comminuted foam as it moves through the process, coating of one type of comminuted foam with another, and/or changes in residence time within a processing step.

Both grindability and separability of foams or mixtures of foams may be quantified by means of a “grindability index” defined below.

Polyurethane foams may be classified in many ways generally known in the art that are not exclusive of each other. For example, foam types are often defined, for example, by the polyol used to make them (polyether, polyester, copolymer, PHD, PIPA, etc.), the isocyanate used to make them (TDI, MDI, etc.), the physical properties of the foam (high-resilience, viscoelastic, high-load-bearing, combustion-modified, etc.), or the geometry of the foam (reticulated, open-cell, closed-cell, fine, coarse, etc.). Foam geometry and polyol type both affect physical properties, and there is some overlap in these classifications. For example, it is possible to have a reticulated ester foam and a reticulated ether foam; most high-load-bearing foams use copolymer polyols; and so forth.

The basic foam-forming components of flexible polyurethane foam include a polyfunctional isocyanate and a polyol. The foaming formulations may include various catalysts, surfactants, antioxidants, fillers, colors, and the like. Conventional polyurethane foam is made with conventional polyols, which are the polyether polyols and polyester polyols, including block polymers of polyether and polyester polyols reactive with an isocyanate under the conditions of the foam-forming reaction.

“Conventional Polyether Foam” refers to conventional polyether flexible polyurethane foam made from conventional polyether polyol, and without the use of polymer polyols (defined below), and without the use of polyester polyols (defined below). Typical conventional polyether polyols for forming flexible polyurethane foams are polyether polyols that are reactive with an isocyanate under the conditions of the foam-forming reaction. The range of molecular weight and range of hydroxyl numbers of polyether polyols are consistent with the production of flexible foams. Specifically, the weight-average molecular weight is from about 1500 to 2000 up to about 6500 to 7000, and preferably in the range of about 3000 to 3600, where the units of molecular weight are g/mol. The hydroxyl number range is from about 20 to 25 up to about 350, and preferably from about 40 to about 60, where the units of a polyol's hydroxyl number are milligrams of potassium hydroxide per equivalent of polyol (mg KOH/equiv). It is possible in order to impart special characteristics to the foam, such as through crosslinking, to use in minor amount a polyol having a hydroxyl number of up to 500 and higher. Examples of polyether polyols useful for making flexible polyurethane foams include, for example, polyether polyols based on addition polymers of ethylene oxide (EO) or propylene oxide (PO) or blends of EO and PO as block or random copolymers, initiated with a low-molecular-weight polyfunctional alcohol such as glycerin or sucrose, and Voranol® polyols from The Dow Chemical Company, such as Voranol 3010, Voranol 3512, and Voranol 3322. Polyether polyols are described in considerable detail in “Polyurethane Handbook, 2nd ed.,” Gunter Oertel, Hanser/Gardner Publications, Inc., 1993, pages .56 to 65.

“Polymer Polyol” refers to polyol that contains finely divided dispersions of polymers that are chemically bound to some extent to the polyol. The dispersed polymers may be, for example, the product of diisocyanates polymerized with aminoalcohols (PIPA polyols), the product of diisocyanates with diamines (polyurea or PHD polyols), or the product of free-radical polymerization of suitable olefinic monomers grafted onto the polyether polyol. Olefins suitably used for polymer polyols include acrylonitrile, styrene, mixtures of acrylonitrile and styrene, or other vinyl monomers. Polymer polyols are described in considerable detail in “Polyurethane Handbook, 2nd ed.,” Gunter Oertel, Hanser/Gardner Publications, Inc., 1993, pages 85 to 86. One characteristic of conventional polyether flexible polyurethane foam is that its formulation contains essentially no polymer polyol.

“High-Resilience Foam” (or “HR foam”) refers to foam having a ball-rebound resilience (defined by ASTM Standard D3770) of greater than about 55%, and a support factor (or SAG factor) of greater than about 2.2. HR foams are typically made using polyols that are ethylene-oxide-capped block polyether triols, with a molecular weight of about 4500 to 6000. Polymer polyols are often used in HR-foam formulations. A stabilizing agent or crosslinker, such as diethanolamine, is often used in HR-foam formulations. HR foams (and some other flexible foams) can be made using TDI, or monomeric or polymeric MDI isocyanates, or mixtures of these isocyanates.

“Ester Flexible Polyurethane Foam” (or “ester foam”) refers to flexible polyurethane foam made with at least some polyester polyol, including block polymers of polyether and polyester polyols. Typical polyester polyols for forming flexible polyurethane foams are polyester polyols that are reactive with an isocyanate under the conditions of the foam-forming reaction. The range of molecular weight and range of hydroxyl numbers of polyester polyols are consistent with the production of flexible foams. Specifically, the molecular weight is from about 1500 to 2000 up to about 6500 to 7000. The hydroxyl number range is from about 20 to 25 up to about 350, and preferably from about 20 to 25 to about 100. It is possible to impart special characteristics to the foam through crosslinking by use of a small amount a polyol having a high hydroxyl number of up to about 500. Examples of polyester polyols useful for making flexible polyurethane foams include, for example, polyester polyols based on adipic acid and diethylene glycol utilizing a glycerol branching agent, Fomrez(R) polyols from Crompton Corporation, Lupraphen(R) polyols from BASF, Lexorez(R) 1101 and Lexorez(R) 1102 polyols from Inolex Chemical Corporation. Polyester polyols and ester foams are described in considerable detail in “Polyurethane Handbook, 2nd ed.,” Gunter Oertel, Hanser/Gardner Publications, Inc., 1993, pages 65 to 71 and 201 to 202.

“Viscoelastic Foam” (also called “visco foam”, or “memory foam”, or “low-resilience foam”, or “energy-absorbing foam”, or “slow-recovery foam”) is a type of flexible foam that is characterized by a slow recovery from deformation and a high vibration damping. This type of foam typically has a ball-rebound resilience (as defined by ASTM Standard D3574) of less than 10%. Such properties permit a widespread use for the foam type in medical, packaging, automotive and sporting goods products, such as energy-absorbing helmets, ear plugs, and special mattresses and pillows that provide a very even pressure distribution. The foams consist of polymeric material that has a glass-transition temperature (T_{g}) slightly below room temperature. A typical example of viscoelastic foam is slow-recovery foam manufactured and used by Tempur Production of Lexington, Ky. in the United States, or by Danfoam in Denmark. In commercial use, the viscoelastic foam sold under the trade name TEMPUR® is suggested in U.S. Pat. No. 6,159,574 to find use in mattresses and cushions.

Viscoelastic polyurethane foams may be made using polyether polyols, may be plasticized, and may be modified with latex modifiers. Viscoelastic polyvinylchloride foams are also known. Viscoelastic polyurethane foams generally have a glass transition temperature (T_{g}) of about −10 to about 45° C., more preferably about 0 to about 35° C., more preferably about 10 to about 30° C., more preferably about 15 to about 25° C., most preferably about 20° C. Such viscoelastic polyurethane foams generally are prepared from a mixture of polyols, with at least one polyol having a weight average molecular weight ranging from about 500 to about 2000, as contrasted with a conventional polyether flexible polyurethane foam which has a mixture of polyols having weight average molecular weights ranging from about 3000 to about 6000.

“Reticulated Foams” are foams in which the cells are essentially devoid of walls and essentially all of the cells are open to one another. They are useful, for example, as filter materials. These foams tend to have larger cells with thicker struts than foams for cushioning applications. These foams may be produced directly using a foam machine, but are generally produced by secondary processing to convert a foam with some fraction of closed cells to a reticulated foam. Secondary processing methods include partial acid or alkaline hydrolysis, thermal shock, controlled explosion, or cyclic compression.

The “grindability” of a loam, is defined as the ease of a foam to be comminuted to form a powder. The grindability of a foam can be improved by mixing chunks of one foam with chunks of one or more other foams to form a foam mixture, which is then comminuted. The grindability of such a foam mixture is improved over the grindability of the individual foams making up the mixture. Foams of different types can be mixed together to form the mixture, or different foams of the same type can be mixed together to form the mixture.

A foam's grindability index (GI) is a numerical indication of the capacity of a foam to be comminuted. Higher values of grindability index indicate more facile grinding and/or sifting, and lower values of grindability index indicate more difficult grinding or sifting.

Grindability index, as stated herein, refers to values calculated using a Farrel two-roll laboratory mill and standard test sieves. Each roll of the mill has a diameter of 15.2 cm (6″), a length of 30.5 cm (12″), and is constructed of hardened cast iron. The rolls rotate at different speeds, one at about 120 rpm, the other at about 30 rpm. The axial gap between the surfaces of the rolls is adjusted to a value of 51 +/−13 microns (0.002 +/−0.0005 inches) and the rolls are adjusted to be parallel within about 13 microns (0.0005 inches). The rolls are cored for the passage of cooling water, which is delivered at a temperature of about 18° C. (65° F.) at a rate of about 4 L/min (1 gpm).

To calculate a grindability index value for a foam or a foam mixture, the foam material is first chopped into chunks of about 0.5 cm to about 2 cm in size. About 50 grams of the chopped foam is passed through the nip of the two-roll mill at a feed rate of about 300 grams per minute, and all of the material is then collected. The collected material is then passed through the nip again. This process is repeated until all of the material has passed through the nip five times. The processed material is then collected and sieved.

Two sieves are used, one with a 75-micron openings and one with 125-micron openings. The 75-micron sieve is a full-height, stainless-steel, 8-inch diameter sieve available from ATM Corporation, Milwaukee, Wis. as model number #200SS8F(75-micron sieve). The 125-micron sieve is a full-height, stainless-steel, 8-inch diameter sieve available from ATM Corporation, Milwaukee, Wis. as model number #120SS8F. Each sieve produces a different grindability index value. Samples are brushed through the sieves using a 5-cm (2″) Chinese-boar-bristle paint brush with the bristles cut down to 1.3 cm (½″) length.

During the sieving process, a sample of the processed material, with a known initial mass of about five to ten grams, is placed on top of a 125-micron sieve. The material is brushed against the screen using the specified brush until the fine material has been separated from the coarse material. Both the fine and coarse fractions are collected with care to collect as much as possible of each fraction. The mass of the fine and coarse fractions are then determined. Three masses are collected for each grindability index test: 1) the initial mass to be sieved; 2) the mass of the collected fine fraction; and 3) the mass of the collected coarse fraction. The same sieving process is repeated for a 75-micron sieve, and for any other sieve sizes of interest.

The grindability index is calculated as the percent through the sieve according to the following formula:

“Grindability index for 125-micron sieve” (GI-125)=100×(mass of fine fraction through 125 micron sieve)/(mass of fine fraction through 125 micron sieve+mass of coarse fraction)

If the “percent recovered” does not exceed 80%, the test should be repeated

with a higher initial mass. The “percent recovered” is calculated using the following formula:

% recovered=100%×(mass of fine fraction+mass of coarse fraction)/(initial mass)

The grindability index for each sieve varies between zero and 100. Higher values indicate more facile grinding and/or sifting, lower values indicate more difficult grinding and/or sifting.

Foams having a GI-125 value less than about 30 typically can not be efficiently comminuted into a separable foam powder for use in creating new foams and products. Grinding these foams in a commercial process can entail recirculating the foams to the grinder persistently just to produce small quantities of usable foam powder. Accordingly, in the past, many of these foams were not recycled by being made into powder, or rarely made into powder.

For an efficient grinding process, foams or foam mixtures to be comminuted typically have a GI-125 of more than about 30. Preferably, foams or foam mixtures to be comminuted into powder have a GI-125 of more than about 50. More preferably, foams or foam mixtures to be comminuted into powder have a GI-125 of more than about 60. Most preferably, foams or foam mixtures to be comminuted have a GI-125 of more than about 70.

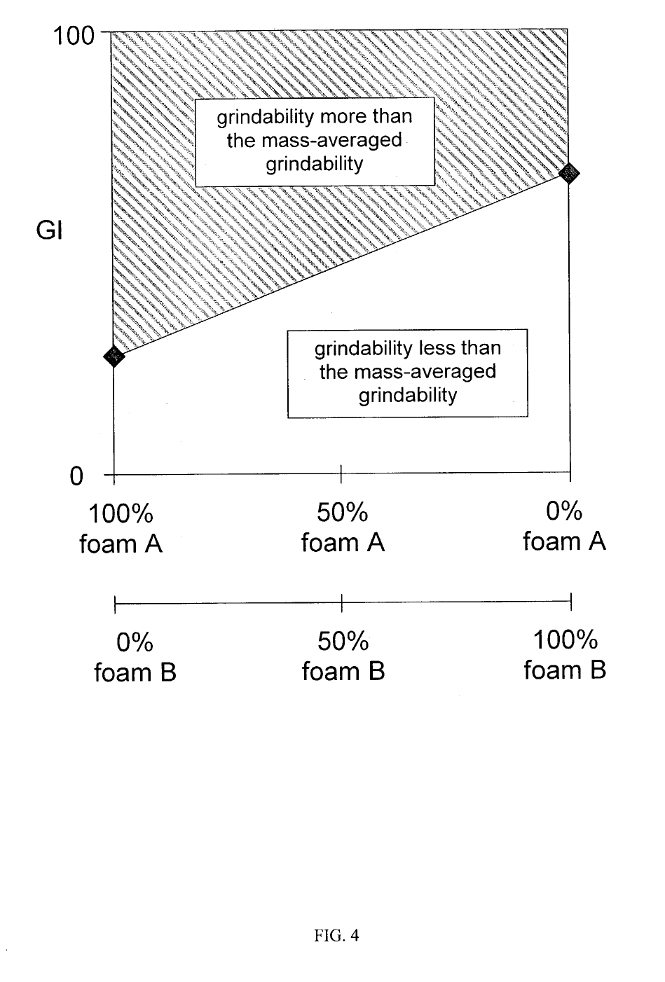

The grindability index of many foams can be increased by mixing the foam with one or more different foams. As shown schematically in FIG. 4, the increase in grindability of the foam mixture surprisingly may be greater than the mass-averaged grindability of foams that make up the foam mixture. Increasing the grindability index of foams by mixing them with other foams is useful for improving the grindability of foams currently comminuted for commercial use, and for allowing foams that would not usually be comminuted because of there low grindability to be comminuted into powders for reuse.

To obtain an appropriate increase in grindability, preferably, the foam mixture comprises at least about 1.0 weight percent of a first foam and at least about 1.0 weight percent of a second foam. More preferably, the foam mixture comprises at least about 5 weight percent of a first and at about 5.0 weight percent of a second foam. Most preferably, the foam mixture comprises at least about 10 weight percent of a first foam and at least about 10.0 weight percent of a second foam.

The grindability index of a foam mixture may be determined by first mixing together small pieces of two or more foams in predetermined weight ratios, then determining the grindability index as described above. The grindability index of a foam mixture as determined in this way may be different from an average of the grindability indices of the individual foams that compose the mixture, as shown in FIG. 4. This “mass-averaged grindability index” of a foam mixture, which may be different than the measured grindability index of a foam mixture, is calculated as follows:

$$mass \text{-} averaged grindability index = \frac{{\sum }_{ i}^{} ( mass of foam type i ) ( GI of foam type i )}{{\sum }_{ i}^{} ( mass of foam type i )}$$

Once a foam or foam mixture has been comminuted to form foam powder with the appropriate particle size, the foam powder can be incorporated into new foams, as depicted in processing modules 108 and 110 of FIG. 1A. The amount of foam powder that may be included in a new foam typically ranges up to about 60% by weight.

Using the foam powder to replace chemicals in recipes for new foam provides an economic and an environmental benefit by decreasing the use of new chemicals. Improved grindability provides finer particles for the same effort. Finer particles are preferable for use as a replacement for chemicals in new foam for several reasons: lower viscosity of powder/polyol slurries, improved foam properties, improved storage, conveying and handling of the powder, improved processing and mixing, and increased amount of foam powder that may be incorporated into a new foam.

### EXAMPLE 1

### Grindability Index of Non-Blended Foams

The grindability index of several foams without blending were calculated as described above using a Farrel two-roll laboratory mill. Table 1 shows the grindability index (GI-125) for an Ester Foam, a Reticulated Foam, a High Resilience Foam, a Viscoelastic Foam and a Conventional Polyether Foam.

The Ester foam was a flexible polyurethane foam, produced from polyester polyol, with a density of about 32 kg/m³, an air flow of about 4 standard cubic feet per minute (scfm), and a regular cell size with about 25 to 30 cells per linear inch. The Reticulated foam was a mixture of reticulated polyurethane foams, approximately 50% made with polyether polyol and 50% with polyester polyol. The foam was produced for filter applications and had a density of about 20 to 30 kg/m³, and a cell size of about 5 to about 30 cells per linear inch. The High-Resilience foam had a density of about 35 kg/m³, and an air flow of 4.8 scfm. The Viscoelastic foam had a density of about 78 kg/m³.

The Conventional Polyether Foam was a conventional polyether slabstock flexible polyurethane foam with a density of 28 kg/m³, an air flow of 3.6 scfm, and a hardness of 145 N as measured at 25% compression by the IFD test described in testing standard ASTM D3574. Such foams are widely available.

TABLE 1
Grindability of Foams

| | | Grindability |
|---|---|---|
| | Density | Index |
| Foam Type | (kg/m³) | (GI-125) |
| Ester Foam | 32 | 0 |
| Reticulated Foam | 25 to 30 | 6.5 |
| High-Resilience foam | 35 | 52.9 |
| Viscoelastic Foam | 78 | 4.5 |
| Conventional Polyether Foam | 28 | 71.5 |

As shown in Table 1, all of the foams but the Conventional Polyether Foam have a GI-125 under 70 and the Viscoelastic, Reticulated, and Ester Foams have a GI-125 of under 30. These low grindability numbers demonstrate that these foams are difficult to grind and may not be grindable on a commercial scale without the present invention.

### EXAMPLE 2

### Grindability Index of Blended Foams

The grindability index (GI-125 and GI-75) of the Conventional Polyether Foam, the High-Resilience Foam and the Viscoelastic Foam described in Example 1 were calculated as described above using a Farrel two-roll laboratory mill. The grindability of each of the three foams were determined in three different ways: 1) the grindability of the pure foam; 2) the grindability of the foam as a mixture with another foam; 3) the grindability of the foams as part of a mixture with the other two foams.

The foam mixture was made by chopping each of the foams into chunks of about 0.5 cm to about 2 cm as was done for the calculation of the grindability index for the individual foams. The foam chunks were then weighed and mixed with foam of the other two varieties in varying mass fractions to produce a variety of foam mixtures. The grindability of each of the foam mixtures were then determined using the Farrel two-roll laboratory mill and standard test sieves as described above.

Table 2 shows each grindability index and particle-size distribution.

TABLE 2
Grindability of Foam Mixtures

| | Blend data (mass fractions) | | | | | | |
|---|---|---|---|---|---|---|---|
| Foam Type | | | | | | | |
| Conventional Polyether Foam (C) | 1.00 | 0.00 | 0.00 | 0.50 | 0.50 | 0.00 | 0.33 |
| High-Resilience Foam (H) | 0.00 | 1.00 | 0.00 | 0.50 | 0.00 | 0.50 | 0.33 |
| Viscoelastic Foam (V) | 0.00 | 0.00 | 1.00 | 0.00 | 0.50 | 0.50 | 0.33 |
| Grindability Indicies | | | | | | | |
| (For above mixtures) | | | | | | | |
| GI-125 (% thru a 125-micron sieve) | 71.5 | 52.9 | 4.5 | 81.6 | 13.1 | 12.7 | 80.2 |
| GI-75 (% thru a 75-micron sieve) | 47.1 | 32.3 | 1.0 | 58.1 | 5.5 | 4.5 | 56.5 |
| Particle-size distribution | C | H | V | C + H | C + V | H + V | C + H + V |
| <75 microns | 47.1 | 32.3 | 1.0 | 58.1 | 5.5 | 4.5 | 56.5 |
| 75 to 125 microns | 24.4 | 20.6 | 3.5 | 23.5 | 7.6 | 8.2 | 123.7 |
| >125 microns | 28.5 | 47.1 | 95.5 | 18.4 | 86.9 | 87.3 | 119.8 |

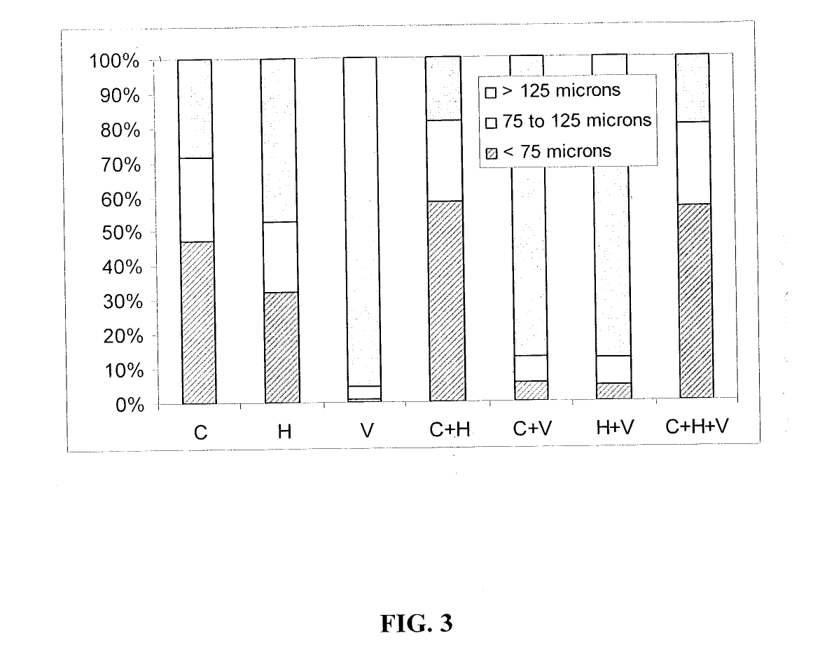

FIG. 3 is a bar graph showing the particle size distribution for each of the foam mixtures. As shown in Table 2, the grindability index of each of the tested foams can be improved by blending the foam with another foam. The grindability index of the Conventional Polyether Foam, which had the highest GI-125 value of any of the non-blended foams, was lower than the grindability index of both the Conventional Foam/High Resilience Foam mixture and the Conventional Polyether Foam/High Resilience Foam/Viscoelastic Foam mixture. Further, the grindability index of each of the foam mixtures is greater than the mass-weighted average of the grindability index of each of the foam components of the mixture. Accordingly, blending the foams improves the grindability of the foams.

### EXAMPLE 3

### Grindability of Ester Foam and a Mixture of Ester Foam with Conventional Polyether Foam

Using the Farrel lab mill previously described, with the fast roll turning at 120 rpm and the slow roll turning at 20 rpm, a sample of 0.5-cm to 2-cm chunks of Ester Foam described in Example 1 were passed through the mill seven times. There was very little grinding, about half of the pieces were merely flattened, and some of the foam was virtually unaffected. Approximately zero percent of the Ester Foam processed in this way was able to pass through a 125-micron sieve.

A second sample of 0.5-cm to 2-cm chunks of Ester Foam was mixed with similarly sized chunks of Conventional Polyether Foam described in Example 1 at a ratio of 50 weight percent. This mixture was passed through the Farrel lab mill seven times under the same operating conditions as Example 3A. The resulting comminuted foam contained essentially no intact foam structure remaining, and essentially was entirely reduced to powder. The particle size of the comminuted foam was evaluated using standard test sieves according to the method described above, with the results that 78.0% of the material passed through a 125-micron sieve, and 54.1% of the material passed through a 75-micron sieve.

### EXAMPLE 4

### Grindability of Reticulated Foams and a Mixture of Reticulated Foams with Conventional Polyether Foam

A two-roll mill was arranged in a grinding circuit with a centrifugal sifter of a type described in published U.S. patent application Ser. No. 09/748,307. Each roll of the mill had a diameter of 30.5 cm (12″), a length of 45.7 cm (18″), and was constructed of hardened cast iron. The rolls rotated at different speeds, one at about 120 rpm, the other at about 30 rpm. The axial gap between the surfaces of the rolls was adjusted to a value of 127 +/−13 microns (0.005 +/−0.0005 inches) and the rolls were adjusted to be parallel within about 13 microns (0.0005 inches). The rolls were cored for the passage of cooling water, which was delivered at a temperature of about 18° C. (65° F.) at a rate of about 4 L/min (1 gpm). Pneumatic conveying was used to move comminuted foam from the mill to the sifter, oversize material from the sifter back to the mill, and foam powder from the sifter to storage.

The Reticulated Foam described in Example 1 was initially reduced in size

to 0.5-cm to 2-cm chunks, and then ground in the grinding circuit described above. A foam powder was produced at a rate of 6.8 kg/h. The particle size of the foam powder was evaluated using standard test sieves according to the method described above, with the results that 89.5% of the material passed through a 180-micron sieve, 66.3% of the material passed through a 125-micron sieve, 31.0% of the material passed through a 75-micron sieve, and 11.5% of the material passed through a 45-micron sieve. A slurry was prepared from 20 parts of the foam powder with 100 parts of VORANOL 3010 polyether polyol from The Dow Chemical Company. The viscosity of the slurry was measured at 25 degrees Centigrade using a Brookfield digital viscometer, model DV-II, using spindle number 4, at speed 20, with the result that the viscosity of the slurry was 1840 mPa-s.

The Reticulated Foam described in Example 1 was initially reduced in size to 0.5-cm to 2-cm chunks, and mixed with similarly sized chunks of Conventional Polyether Foam described in Example 1 to prepare a mixture of 20% Conventional Polyether Foam and 80% Reticulated Foam. That mixture was then ground in grinding circuit described above. A foam powder was produced at a rate of 28.6 kg/h. The particle size of the foam powder was evaluated using standard test sieves using the method described above, with the results that 100% of the material passed through a 180-micron sieve, 75.5% of the material passed through a 125-micron sieve, 39.4% of the material passed through a 75-micron sieve, and 10.7% of the material passed through a 45-micron sieve. A slurry was prepared from 20 parts of the foam powder with 100 parts of VORANOL 3010 polyether polyol from The Dow Chemical Company. The viscosity of the slurry was measured at 25 degrees Centigrade using a Brookfield digital viscometer, model DV-II, using spindle number 4, at speed 20, with the result that the viscosity of the slurry was 1530 mPa-s.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art will recognize that the numerical ranges disclosed inherently support any range within the disclosed numerical ranges even though a precise range limitation is not stated verbatim in the specification because this invention can be practiced throughout the disclosed numerical ranges.

What is claimed is:

1. A method of grinding polymer foams comprising:
blending pieces comprising a first foam and a second foam together to form a foam mixture; and
grinding the foam mixture to form a comminuted foam comprising comminuted first and second foams,
wherein the first foam has a different composition or structure than that of the second foam and a grindability index GI-125 of the foam mixture is higher than a mass-averaged grindability index GI-125 of the foam pieces.

2. The method of claim 1, wherein the first foam has a grindability index GI-125 of less than 50.

3. The method of claim 1, wherein the foam mixture has a grindability index GI-125 of greater than 50.

4. The method of claim 1, wherein the first or second foam comprises a foam selected from the group consisting of ester foam, reticulated foam, high-resilience foam, viscoelastic foam and conventional polyether foam.

5. The method of claim 1, further comprising separating the comminuted foam to form a foam-powder component and an oversize-particles component.

6. The method of claim 5, wherein the foam-powder component has a particle size of less than 2 mm.

7. The method of claim 5, further comprising regrinding the oversize-particles component.

8. The method of claim 5, wherein the foam mixture comprises at least 1 weight percent first foam and at least 1 weight percent second foam.

9. A method of preparing a polymer foam from recycled foams comprising:
blending pieces of a first foam and pieces of a second foam together to form a foam mixture;
grinding the foam mixture to form a comminuted foam comprising comminuted first and second foams;
separating the comminuted foam into a fraction comprising foam powder and a fraction comprising oversize particles;
mixing the foam powder with a polymerizable liquid; and
preparing a polymer foam from the foam powder and polymerizable liquid mixture,
wherein the first foam has a different composition or structure than that of the second foam.

10. A foam powder comprising a foam mixture comprising:
a first comminuted foam; and
a second comminuted foam,
wherein the first foam has a different composition or structure than that of the second foam and a grindability index GI-125 of the foam mixture is higher than a mass-averaged grindability index GI-125 of the first and second foams.

11. The foam powder of claim 10, wherein the first comminuted foam has a grindability index GI-125 of less than 50.

12. The foam powder of claim 10, wherein the first comminuted foam comprises a foam selected from the group consisting of ester foam, reticulated foam, high-resilience foam, viscoelastic foam and conventional polyether foam.

13. The foam powder of claim 10, wherein the first comminuted foam has a particle size of less than 2 mm.

14. The foam powder of claim 10, wherein the foam powder comprises at least 1 wt % first foam and at least 1 wt % second foam.

15. An article comprising a foam mixture comprising:
a first comminuted foam; and
a second comminuted foam,
wherein the first foam has a different composition or structure than that of the second foam and a grindability index GI-125 of the foam mixture is higher than a mass-averaged grindability index GI-125 of the first and second foams.

16. The article of claim 15, wherein the first comminuted foam has a grindability index G-125 of less than 50.

17. The article of claim 15, wherein the foam comprises at least 3 wt % comminuted foam.

18. The article of claim 15, wherein the first comminuted foam and second comminuted foam have a particle size of less than 2 mm.

19. The article of claim 15, wherein the first and second foam comprises a foam selected from the group consisting of ester foam, reticulated foam, high-resilience foam, viscoelastic foam and conventional polyether foam.

20. The article of claim 15, wherein the foam is used to produce an item.

21. A method of making a slurry of comminuted foam in a polymerizable liquid comprising:
blending pieces of a first foam and pieces of a second foam together to form a foam mixture;
grinding the foam mixture to form a comminuted foam comprising comminuted first and second foams; and
mixing the comminuted foam with a polymerizable liquid,
wherein the first foam has a different composition or structure than that of the second foam and a grindability index GI-125 of the foam mixture is higher than a mass-averaged grindability index GI-125 of the first and second foams.

22. A method of grinding a foam comprising:
mixing a first foam selected from the group consisting of ester foam, reticulated foam, high-resilience foam and viscoelastic foam with a second conventional polyether foam to form a foam mixture;
grinding the foam mixture,
wherein the first foam has a different composition or structure than that of the second foam and a grindability index GI-125 of the foam mixture is higher than a mass-averaged grindability index GI-125 of the first and second foams.

23. The method of claim 22, wherein the first foam comprises an ester foam.

24. A method of grinding polymer foams comprising:
blending pieces of a first foam and pieces of a second foam together to form a foam mixture; and
grinding the foam mixture to form a comminuted foam comprising comminuted first and second foams,
wherein the first foam has a different composition or structure than that of the second foam and wherein the first or second foam comprises a foam selected from the group consisting of ester foam, reticulated foam, high-resilience foam, viscoelastic foam and conventional polyether foam.

25. A foam powder comprising a foam mixture comprising:
a first comminuted foam; and
a second comminuted foam,
wherein the first foam has a different composition or structure than that of the second foam and wherein the first or second foam comprises a foam selected from the group consisting of ester foam, reticulated foam, high-resilience foam, viscoelastic foam and conventional polyether foam.

26. A article comprising a foam mixture comprising:
a first comminuted foam; and
a second comminuted foam,
wherein the first foam has a different composition or structure than that of the second foam and wherein the first or second foam comprises a foam selected from the group consisting of ester foam, reticulated foam, high-resilience foam, viscoelastic foam and conventional polyether foam.

27. A method of making a slurry of comminuted foam in a polymerizable liquid comprising:
blending pieces of a first foam and pieces of a second foam together to form a foam mixture;
grinding the foam mixture to form a comminuted foam comprising comminuted first and second foams; and
mixing the comminuted foam with a polymerizable liquid,
wherein the first foam has a different composition or structure than that of the second foam and wherein the first or second foam comprises a foam selected from the group consisting of ester foam, reticulated foam, high-resilience foam, viscoelastic foam and conventional polyether foam.

28. A method of grinding polymer foams comprising:
blending pieces of a first foam and pieces of a second foam together to form a foam mixture; and
grinding the foam mixture to form a comminuted foam comprising comminuted first and second foams,
wherein the first foam has a different composition or structure than that of the second foam and wherein the first foam comprises a foam selected from the group consisting of ester foam, reticulated foam, high-resilience foam and viscoelastic foam, and the second foam comprises a conventional polyether foam.

29. A foam powder comprising a foam mixture comprising:
a first comminuted foam; and
a second comminuted foam,
wherein the first foam has a different composition or structure than that of the second foam and wherein the first foam comprises a foam selected from the group consisting of ester foam, reticulated foam, high-resilience foam and viscoelastic foam, and the second foam comprises a conventional polyether foam.

30. A article comprising a foam mixture comprising:
a first comminuted foam; and
a second comminuted foam,
wherein the first foam has a different composition or structure than that of the second foam and wherein the first foam comprises a foam selected from the group consisting of ester foam, reticulated foam, high-resilience foam and viscoelastic foam, and the second foam comprises a conventional polyether foam.

31. A method of making a slurry of comminuted foam in a polymerizable liquid comprising:
blending pieces of a first foam and pieces of a second foam together to form a foam mixture;
grinding the foam mixture to form a comminuted foam comprising comminuted first and second foams; and
mixing the comminuted foam with a polymerizable liquid,
wherein the first foam has a different composition or structure than that of the second foam and wherein the first foam comprises a foam selected from the group consisting of ester foam, reticulated foam, high-resilience foam and viscoelastic foam, and the second foam comprises a conventional polyether foam.
